(19) United States
(12) Patent Application Publication
(10) Pub. No.: US 2006/0177618 A1
(43) Pub. Date: Aug. 10, 2006

(54) Tape and tape cassette containing the tape

(75) Inventors: Tsutomu Kato, Nagoya-shi (JP); Toshio Takahashi, Nagoya-shi (JP); Hitomi Hioki, Nagoya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/348,341

(22) Filed: Feb. 7, 2006

(30) Foreign Application Priority Data
Feb. 7, 2005 (JP) 2005-030325

(51) Int. Cl. B32B 33/00

(52) U.S. Cl. 428/40.1

(57) ABSTRACT

The disclosure describes a print tape which allows a separating sheet to be removed easily and quickly without bending the print tape and a tape cassette containing the tape. The print tape is accommodated in the tape cassette and has a tape base material, an adhesive agent layer and a separating sheet. Side portions are each provided adjacent both sides, in a width direction, of the tape base material. A back scoring portion is provided in a center in the width direction of the separating sheet. Therefore, both sides in the width direction of an end portion of the print tape can be gripped and pulled in a direction in which they separate from each other. As a consequence, the separating sheet separates along the back scoring and a center portion of the tape base material is freed for application. Because of the structure, the separating sheet can be peeled easily and quickly from the printed base material without bending the print tape.

This application claims priority from JP 2005-030325, filed Feb. 7, 2005, the content of which is incorporated in its entirety herein by reference thereto.

### BACKGROUND

The disclosure relates to a tape and a tape cassette containing the tape and more specifically to a tape in which a separating sheet is bonded separably to a base material and a tape cassette containing the tape.

Conventionally, a print tape for use in a tape printer is so structured that a separating sheet is bonded to a face of a long tape base material via an adhesive agent and stored inside the tape cassette. The print tape is pulled from a tape cassette and printed by a thermal head, or the like, of the tape printer. Then, the resulting printed tape is cut to a length for use and expelled from a tape outlet. The print tape expelled is bonded to an object by separating the separating sheet pasted to a face (rear face) opposite to the print face of the tape base material.

Such a print tape varies from a narrow tape to a wide tape depending on the demand of the user. However, such print tapes so structured are not preferable from the viewpoint of cost because a tape cassette of a size to accommodate the width of each tape needs to be prepared. Thus, a half cut print tape is well known. In the tape a cut line is provided in only the tape base material along the length between the sides in the width direction of the print tape. Because this print tape has the cut line in its tape base material, the size of the tape cassette does not need to be changed. Then, a print tape having a desired width can be obtained by separating a central portion in the width direction of the print tape, expelled after printing, from the separating sheet. In addition to this tape cassette, as disclosed in Japanese Laid Open Patent Publication No. HEI 11-78086, there is well known a tape print apparatus in which a roller for supporting a pair of cutting blades for incising a printing object layer (tape base) of a printing object tape is provided on a carrying passage for carrying the printing object tape (print tape) within the tape cassette.

As a means for peeling the separating sheet of the print tape having the half cuts from the base material, for example, there is a method of recognizing a border between the tape base material and the separating sheet in the cut line of the print tape and inserting a nail tip, a nail edge or the like into the border to wind up the separating sheet. Additionally, a method of causing separation of the separating sheet by giving a curvature to the vicinity of a cut face, and the like are used.

### SUMMARY

However, an activity of recognizing the border between the printing object layer (tape base material) and the separating layer (separating sheet) in a half cut printing object tape (print tape) to be discharged from the tape print device described in Japanese Laid Open Patent Publication No. HEI 11-78086 is not always easy to perform, sometimes there are accompanying difficulties. For example, if the vicinity of the cut face is provided with a curvature, when the separating sheet is peeled from the printing object layer, the corners and ends of the printing object tape can be bent so that the printed tape is curved, which is a problem to be solved. Further, if the printing object tape is bent or curved, the separating layer separates from the printing object layer, thereby leading to separating or peeling of the tape, which is another problem to be solved. If the printing object layer of the printing object tape is bent, when it is bonded to a bonding object, the printing object layer separates, thereby resulting in an increased likelihood of peeling, which is another problem.

To address the above problems, there is provided a tape comprising a base material and a separating sheet bonded separably to one face of the base material via an adhesive agent, the tape having a pair of cut lines in the base material provided in a vicinity of both sides in a width direction of the tape and along a length of the tape; and a cut line in the separating sheet scored along the length of the tape.

Further, there is provided a tape cassette containing a tape which allows the separating sheet to be removed easily from the base material.

### BRIEF DESCRIPTION OF THE DRAWINGS

The invention will be described with references to the drawings, in which:

FIG. 1 is a perspective view of a tape cassette;

FIG. 2 is a plan view of a lower case after an upper case is removed;

FIG. 3 is a view of a first exemplary embodiment of a print tape as seen from a side of a tape base material;

FIG. 4 is a view of the print tape as seen from the side of a separating sheet;

FIG. 5 is a sectional view taken along the line I-I in FIG. 3;

FIG. 6 is an explanatory diagram of an operation of separating the separating sheet from the print tape (as seen from the side of a tape base material);

FIG. 7 is an explanatory diagram of the operation of separating the separating sheet from the print tape (as seen from the side of a tape base material);

FIG. 8 is a lateral sectional view of the print tape according to a second exemplary embodiment; and

FIG. 9 is an explanatory diagram of an operation of separating the separating sheet from a print tape (as seen from a side of a tape base material of the second embodiment).

### DETAILED DESCRIPTION OF EMBODIMENTS

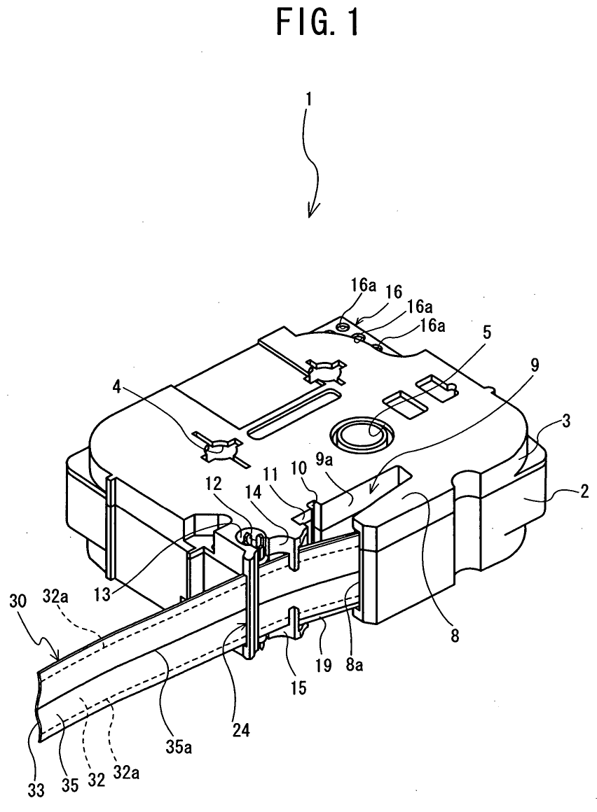

Hereinafter a tape cassette 1 will be described with reference to the accompanying drawings. The bottom right of FIG. 1 is specified as the front side of the tape cassette 1 and the top left of FIG. 1 is specified as the rear side. In the following description, a half cut print tape 30 refers to the print tape 30 whose tape base material 32 is scored preliminarily.

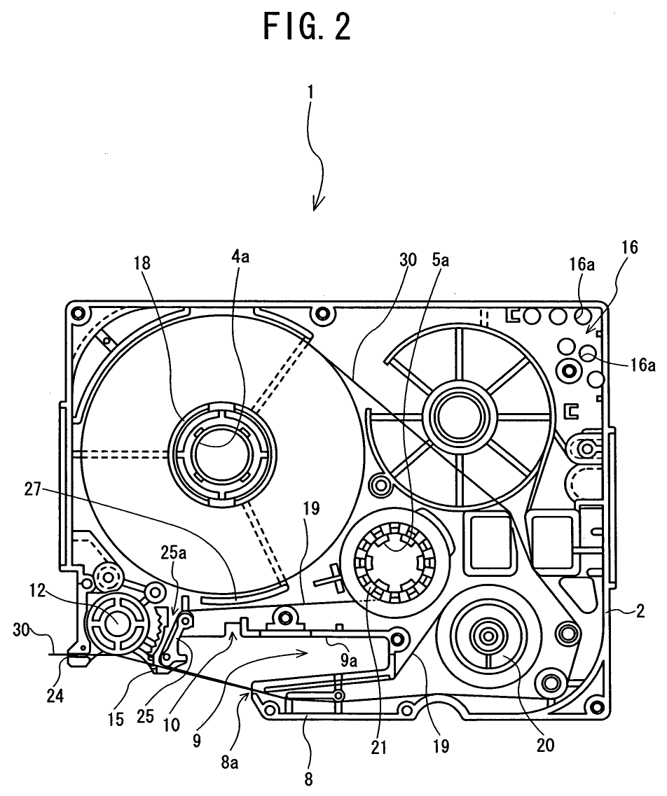

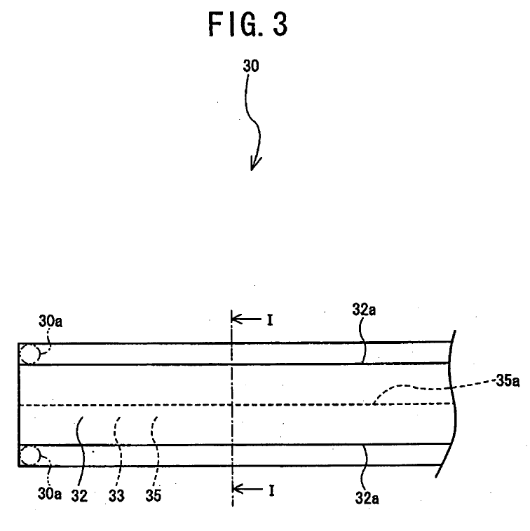

The tape cassette 1 includes the half cut print tape 30 (see FIG. 2). The print tape 30 described later comprises a long tape base material 32 and a separating sheet 35 pasted separably to one face of the tape base material 32 via an adhesive agent layer 33 as shown in FIGS. 3 to 5. The feature of the print tape 30 is that the tape base material 32 and the separating sheet 35 are pre-scored at specified positions. As a consequence, the separating sheet 35 may be separated easily from the print tape 30 without bending the print tape 30.

The tape cassette 1, shown in FIG. 1, is mounted detachably on a tape printer (not shown). The tape cassette 1 comprises a lower case 2 and an upper case 3 fixed on the top of the lower case 2.

As shown in FIG. 1, a supporting hole 4 and a supporting hole 5 are formed in the upper case 3 of the tape cassette 1. The supporting hole 4 supports a tape spool 18 (see FIG. 2) rotatably which supports the print tape 30 such that the tape is wound therearound with a separating sheet 35 thereof facing outward. The supporting hole 5 supports a ribbon wind-up spool 21. (see FIG. 2) which pulls out an ink ribbon 19 from a ribbon spool 20 (see FIG. 2) and winds up the used ink ribbon 19 when printing characters, symbols, graphics or the like on the tape base material 32 of the print tape 30. As shown in FIG. 2, supporting holes 4a, 5a are respectively formed in the lower case 2 such that they are continuous from the supporting holes 4, 5 of the upper case 3 and oppose them.

As shown in FIG. 1, an arm portion 8 is provided on the side face of the front side (the bottom right in FIG. 1 (all directions are in terms of the tape cassette as shown in FIG. 1) of the tape cassette 1. The arm portion 8 brings the print tape 30, pulled from the tape spool 18 (see FIG. 2), together with the ink ribbon 19, pulled out from the ribbon spool 20 (see FIG. 2), to a head mounting portion 9 described later and feeds the opposed print tape 30 and ink ribbon 19 from an opening 8a. The head mounting portion 9 is provided in a vicinity of the opening 8a of the arm portion 8. The head mounting portion 9 is formed such that it is surrounded by the arm portion 8 and a wall portion 9a opposing the arm portion 8, the head mounting portion 9 being an open space in which a thermal head (not shown) of a tape printer is to be mounted. Then, a first fitting portion 10 is formed in the wall portion 9a which defines the head mounting portion 9 such that it is concave toward the rear of the tape cassette 1 and extends vertically. A second fitting portion 11 is formed in the side wall on the left side (the left side in FIG. 1) of the head mounting portion 9 such that it is concave in a direction perpendicular to the first fitting portion 10 (direction along the wall portion 9a). The first fitting portion 10 and the second fitting portion 11 are fitted to a respective two protrusions (not shown) formed on a head holder (not shown) supporting the thermal head of the tape printer. As a result, mounting of the thermal head to the head mounting portion 9 can be carried out securely without interference with the print tape 30 and the ink ribbon 19.

As shown in FIG. 1, a supporting hole 13, extending vertically, is provided downstream of the head mounting portion 9 in the running direction of the print tape 30 and the ink ribbon 19. A tape feeding roller 12 is supported rotatably inside the supporting hole 13. The tape feeding roller 12 pulls the print tape 30 from the tape spool 18 (see FIG. 2) in cooperation with a pressure contact roller (not shown) of the tape printer disposed opposing the tape feeding roller 12. A pair of restricting members 14, 15, comprising an upper member and a lower member, are provided upstream in the running direction of the print tape 30 in the vicinity of the tape feeding roller 12. The restricting members 14, 15 guide the print tape 30 toward a tape discharge port 24, restricting movement in the width direction of the print tape 30, on which characters or the like are printed, on the downstream side of a thermal head (not shown). As shown in FIG. 2, a guide portion 25 guides the used ink ribbon 19, after passing through the head mounting portion 9, toward the ribbon wind-up spool 21, separating the ink ribbon 19 from the print tape 30. The guide portion 25 is provided adjacent the restricting members 14, 15. A guide hole 25a, through which the used ink ribbon 19 passes, is provided along the guide portion 25.

Further, as shown in FIGS. 1 and 2, a cassette detecting portion 16 is formed at the right rear edge of the tape cassette 1 (the top right of FIG. 1). A plurality of switch holes 16a are formed in the cassette detecting portion 16 and have a predetermined pattern in order to detect the kind of tape cassette 1 mounted in the tape printer (not shown) (for example, the kind of the tape cassette 1 is specified depending on the width of the print tape 30, the color of ink applied to the rink ribbon 19 and the like). The formation pattern of the switch holes 16a differs depending on the kind of tape cassette 1. The switch holes 16a are detected based on a combination of ON/OFF states of a plurality of detecting switches disposed on the tape printer (not shown).

Next, the internal structure of the tape cassette 1 will be described. As shown in FIG. 2, the tape spool 18 on which the print tape 30 is wound, is disposed rotatably via the supporting hole 4 (see FIG. 1) in the rear, left (the top, left of FIG. 2) of the lower case 2. The ribbon spool 20, on which the ink ribbon 19 is wound, is disposed rotatably in the right front portion (the bottom, right of FIG. 2) of the lowercase 2. The ribbon wind-up spool 21 is disposed rotatably via the supporting hole 5 (see FIG. 1) in a section sandwiched by the tape spool 18 and the ribbon spool 20. The ribbon wind-up spool 21 pulls the ink ribbon 19 from the ribbon spool 20 and winds up the ink ribbon 19 used for printing characters or the like. A partition wall 27 is provided such that it is erected between the used ink ribbon 19, carried toward the ribbon wind-up spool 21 through the guide hole 25a, and the print tape 30 wound around the tape spool 18. The partition wall 27 prevents the ink ribbon 19 and the print tape 30 from making contact with each other.

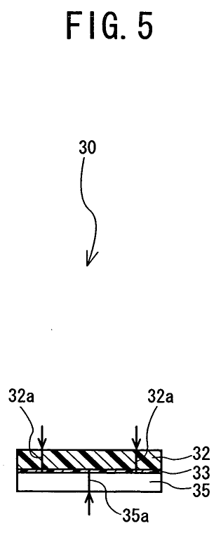

Next, the carrying passage of the print tape 30 within the tape cassette 1 will be described. As shown in FIG. 2, the print tape 30 is pulled from the tape spool 18 by the tape feeding roller 12 and a pressure contact roller of a tape printer (not shown). Next, the print tape 30 pulled from the tape spool 18 is carried toward the arm portion 8 and toward the front portion (bottom in FIG. 2) of the head mounting portion 9 from the opening 8a of the arm portion 8. At the time, the print tape 30 leaves the opening 8a, the side of the print tape 30 having the tape base material 32 (see FIG. 5) faces the wall portion 9a and the side of the print tape 30 having the separating sheet 35 (see FIG. 5) faces outwardly, or away, from the head mounting portion 9. Then, the ink ribbon 19 is laid over the tape base material 32 of the print tape 30. The print tape 30 is carried together with the ink ribbon 19 between the thermal head and platen of a tape printer (not shown) and characters and the like are printed on a print face of the tape base material 32 of the print tape 30. After that, the printed print tape 30 is restricted in terms of its position in the width direction by the pair of the restricting members 14, 15 (see FIGS. 1 and 2) so that it is discharged from the tape discharge port 24 by the rotation of the tape feeding roller 12.

The carrying passage of the ink ribbon 19 within the tape cassette 1 will now be described. As shown in FIG. 2, the ink ribbon 19 is pulled from the ribbon spool 20 via the carrying passage of the ink ribbon 19 by a rotation of the ribbon wind-up spool 21. First, the ink ribbon 19 that is pulled from the ribbon spool 20 is carried toward and through the arm portion 8 and then exits the arm portion 8 toward the front side (the bottom of FIG. 2) of the head mounting portion 9 via the opening 8a. At this time, the ink ribbon 19 is laid over the tape base material 32 of the print tape 30. Further, the ink ribbon 19 is pressed against the tape base material 32 of the print tape 30 by the thermal head (not shown) and the platen (not shown) for printing characters and the like on a print face of the tape base material 32. After that, the used ink ribbon 19 separates from the print tape 30, passes through the guide hole 25a of the guide portion 25 adjacent the restricting members 14, 15 and is wound up on the ribbon wind-up spool 21. Although not shown, a clutch spring is mounted on the bottom of the ribbon wind-up spool 21. The clutch spring prevents the ink ribbon 19 from becoming slack by a reversal of the ribbon wind-up spool 21.

The print tape 30 will be described with reference to FIGS. 3 to 5. As shown in FIGS. 3, 4, and 5, the print tape 30 comprises the long tape base material 32, the adhesive agent layer 33 formed on one surface of the tape base material 32, and the long separating sheet 35 bonded separably on the one surface of the tape base material 32, i.e., on the adhesive agent layer 33. In the tape base material 32, the face on an opposite side to the one surface on which the adhesive agent layer 33 is formed, serves as a print face on which printing can be done. The material of the separating sheet 35 is paper or a resin film. The face of the separating sheet 35, to be bonded to the tape base material 32, is coated with silicone film as a separating agent (not shown in the drawings). As shown in FIGS. 3 and 5, half cut portions 32a, 32a, which are scored along the length of the print tape 30, are provided in the vicinity of both sides in the width direction of the tape base material 32. The half cut portions 32a are not provided in the separating sheet 35 and they are provided apart by a predetermined distance from both sides in the width direction of the tape base material 32. For example, in the print tape 30 of this embodiment, the half cut portions 32a, 32a are provided in the tape base material 32 such that the width of the central portion, excluding both sides in the width direction, is 12 mm to 14 mm when the overall tape base material 32 is 18 mm wide. Thus, the half cut portions 32a are provided 2 mm to 3 mm from both sides of the tape base material 32. The half cut portions 32a, shown in FIG. 3, correspond to cut lines in the base material 32.

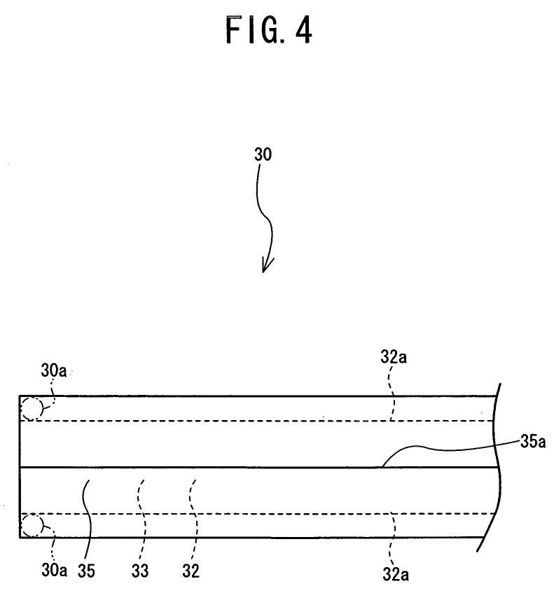

As shown in FIGS. 4 and 5, a back scoring portion 35a, which is a cut line along the length of the separating sheet 35, is provided in the center in the width direction of the separating sheet 35. The back scoring portion 35a is a cut line similar to the half cut portions 32a and is not provided in the tape base material 32. The back scoring portion 35a can be provided in the interval corresponding, at least, to the section between the pair of half cut portions 32a, 32a. Preferably, the back scoring portion 35a is provided along the center in the width direction of the separating sheet 35. Thus, the back scoring portion 35a, shown in FIG. 4, corresponds to a cut line in the separating sheet.

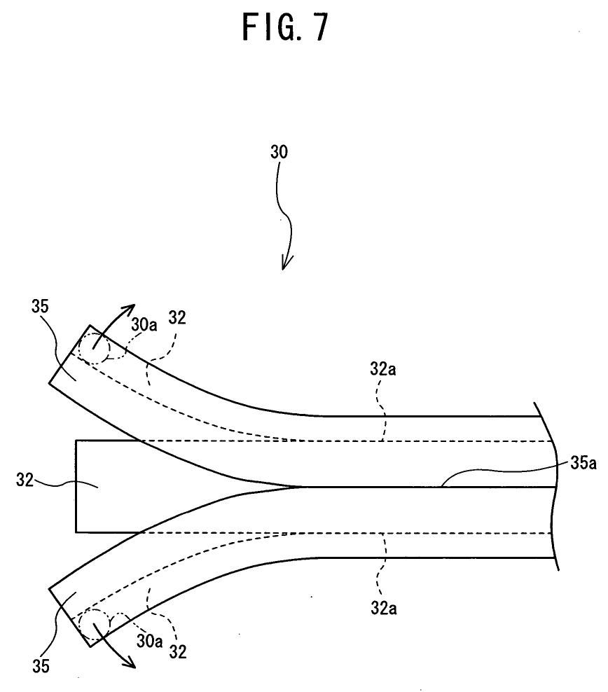

Next, a method for peeling the separating sheet 35, of the print tape 30 having the above-described structure, will be described with reference to FIGS. 3 to 7. As shown in FIGS. 3 and 4, grip portions 30a, 30a having an area which can be gripped with one hand are provided outside the half cut portions 32a, 32a on both sides in the width direction of the tape base material 32 at an end portion (the left end in FIG. 3) in the length direction of the print tape 30. As shown in FIGS. 3 and 4, the grip portions 30a, 30a are provided at an end portion of the print tape 30 constituted by overlaying the tape base material 32, the adhesive agent layer 33 and the separating sheet 35. Next, the grip portions 30a, 30a are gripped from the sides of the tape base material 32 and the separating sheet 35 with the fingers. Then, the grip portions 30a, 30a are pulled in directions away from each other in the substantially same plane including the print tape 30. As a consequence, as shown in FIG. 7, the separating sheet 35, whose grip portions 30a, 30a, are gripped by the fingers, is separated gradually along the back scoring portion 35a into two sections along the length of the separating sheet 35.

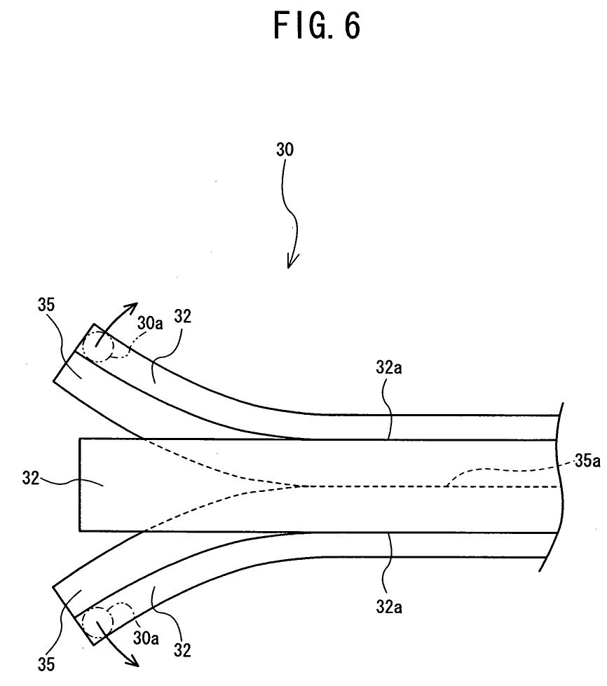

On the other hand, as shown in FIG. 6, both side portions, in the width direction of the tape base material 32, are pulled in a direction in which they separate from each other when they are gripped by the grip portions 30a, 30a. The tape base material 32 also separates at the half cut portions 32a, 32a to divide gradually into three sections. At this time, both side portions of the tape base material 32 and the two sections of the separating sheet 35 are gripped and fixed by the fingers at a pair of the grip portions 30a, 30a. As a result, only the central portion of the tape base material 32, which is not held, is separated from the separating sheet 35. The both side portions of the tape base material 32, separate from the central portion of the tape base material 32, in a state in which they are fixed to the separating sheet 35. Thus, the print tape 30 enables the separating sheet 35 to be separated from the tape base material 32 without bending the central portion in the width direction of the tape base material 32 by a simple operation of only pulling the grip portions 30a, 30a in a direction in which they separate from each other. Further, the user's hand, or hands, do not touch the central portion of the tape base material 32 in the series of actions for separating the separating sheet 35 from the print tape 30, so that the print face of the tape base material 32 is not stained or otherwise damaged.

As described above, the tape cassette 1 of the first exemplary embodiment contains the print tape 30 internally. The print tape 30 integrally comprises the long tape base material 32 and the separating sheet 35 bonded separably to one face of the tape base material 32 via the adhesive agent layer 33. The half cut portions 32a, 32a are provided in the vicinity of the sides in the width direction of the tape base material 32 by scoring side portions along the length of the tape base material 32. In this embodiment, the back scoring portion 35a is provided in the center in the width direction of the separating sheet 35 by scoring along the length of the separating sheet 35. Further, the grip portions 30a, 30a, having sufficient area to be gripped with the user's fingers, are set outside the half cut portions 32a, 32a on both sides in the width direction of the tape base material 32 and at an end of the print tape 30. To separate the separating sheet 35 from the print tape 30, the grip portions 30a, 30a are gripped and pulled in a direction in which they depart from each other in the same plane that includes the print tape 30. As a consequence, the separating sheet 35 is cut gradually along the back scoring line 35a so that it is cut into two sections along the length and the tape base material 32 is also cut along the half cut portions 32a, 32a. As a result, only the central portion, containing the printing in the width direction of the tape base material 32, is separated from the separating sheet 35. Finally, the print tape 30 allows the separating sheet 35 to be peeled easily and quickly without bending the print tape 30 itself, namely, without bending the central portion in the width direction of the tape base material 32 used.

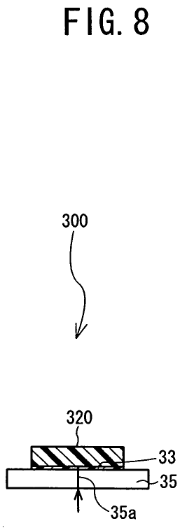

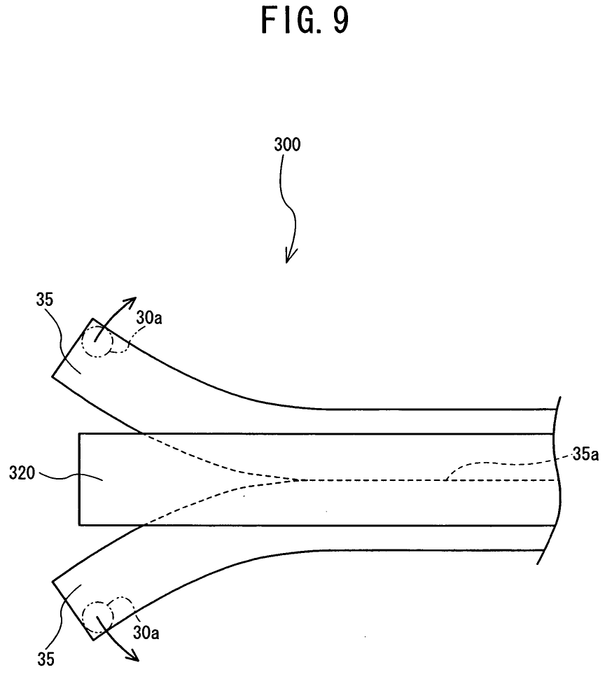

Next, the tape cassette of a second exemplary embodiment will be described with reference to FIGS. 8 and 9. The tape cassette of the second embodiment has a print tape 300 which is a modification of the print tape 30 of the first embodiment. The print tape 300 is different only in the structure of the tape base material 32 from that of the print tape 30 shown in FIG. 5. The structure of the tape cassette, which holds the print tape 300, is the same as that in the first embodiment. Thus, principally the structure of the print tape 300 will be described. For other structural features, the description of the first embodiment should be referred to. The same reference numerals as those used for the first embodiment are used for portions having the same structure as the print tape 30. In the description below, FIGS. 5 and 6 will be referred to in order to compare the structure of the print tape 30 of the first embodiment to the structure of the print tape 300 of the second embodiment.

The print tape 300 will now be described. As shown in FIG. 8, the print tape 300 comprises a tape base material 320 with both side portions in the width direction of the long tape base material 32, removed substantially along what were the half cut portions 32a, 32a of the first embodiment(see FIG. 5), the adhesive agent layer 33 formed on one face of the tape base material 320 and the long separating sheet 35 bonded separably via the adhesive agent layer 33, to the one face of the tape base material 320. Like the first embodiment, the back scoring portion 35a is provided in the center of the width direction of the separating sheet 35 by scoring along the length of the separating sheet 35.

Next, the method for peeling the separating sheet 35 of the print tape 300, having the above described structure, will be described with reference to FIG. 9. First, the grip portions 30a, 30a having an area large enough to be gripped with one hand are set on each portion of the separating sheet 35 outside the width of the tape base material 320 and at an end in the length direction (left end in FIG. 9) of the print tape 300. Next, the grip portions 30a, 30a are securely gripped and pulled gradually in the direction in which they separate from each other in the substantially the same plane that includes the print tape 300. As a consequence, the separating sheet 35, whose grip portions 30a, 30a are securely gripped, is separated gradually along the back scoring portion 35a so that the separating sheet 35 is separated into two sections along the length of the separating sheet 35. On the other hand, because the tape base material 320 is gradually peeled from the separating sheet 35 via the adhesive agent layer 33 (see FIG. 8), a user obtains only the printed tape base material 320 for actual use.

Because in the print tape 300 of the second embodiment, the side portions in the width direction found in the tape base material 32 do not exist, a border between the tape base material 320 and the separating sheet 35 is easy to recognize. As a result, the separating sheet 35 is easily separated from the tape base material 320. Further because the tape base material 320 has no side portions in the width direction, as found in the tape base material 32 (see FIGS. 5 and 6) that are not intended for use, the amount of waste can be reduced.

The tape and tape cassette, containing one of the exemplary tapes, are not restricted to the first and second embodiments but may be modified in various ways.

For example, although the first and second embodiments use a print tape having a width of 18 mm, the print tape may be wider or narrower than 18 mm and the disclosure can be applied to a variety of tapes having other widths. In the first embodiment, the position of the half cut portions 32a, 32a may be adjusted appropriately to obtain a tape width as desired by user. It is preferable to provide areas which allow grip portions 30a, 30a, large enough to be gripped with the hand, to be set on both sides in the width direction of the print tape 30.

As described above, for the tapes, if both side portions, in the width direction of the tape, are gripped at an end in the length direction of the tape with a hand and pulled in a direction in which they depart from each other in the substantially same plane, the separating sheet is separated into two sections along the cut line in the separating sheet. In the first embodiment, the base material is cut along a pair of cut lines, to divide the base material into three sections. In the second embodiment, no base material is provided to the side portions. Thus, the side portions of the base material and the separating sheet divided into two sections, or only the divided separating sheet of the second embodiment, are securely gripped be a hand, so that the central portion of the base material can be removed from the separating sheet. As a consequence, the separating sheet can be removed easily and quickly by the simple operation of only pulling the side portions in the width direction of the tape without bending the tape itself.

As discussed, the cut line in the separating sheet within the interval opposing the center portion of the base material. As a result, the side portions of the base material of the first embodiment are gripped with a hand and can be removed in a condition in which they are bonded to the separating sheet. Thus, the side portions of the base material are separated from the central portion of the base material by pulling the side portions of the print tape in a direction in which they depart from each other. The result is only the central portion of the base material, not gripped, is removed from the separating sheet.

In the first embodiment, the cut lines in the base material may be separated from the sides of the tape by a predetermined distance. In the second embodiment, the base material is only provided in the center portion separated from the sides of the print tape by the predetermined distance. Consequently, portions having an area large enough to be gripped can be secured on both sides in the width direction of the tape.

In the second embodiment, because both side portions of the tape base material do not exist, a border between the base material and the separating sheet is easy to recognize. Thus, the separating sheet can be removed from the base material more easily. A user can obtain only the central portion in the width direction of the base material that is for actual use. Further, because the side portions do not exist, the quantity of waste can be reduced.

The tape cassette can accommodate any tape described above which allows the separating sheet to be removed from the base material easily. Consequently, a printed print tape which allows the separating sheet to be removed easily can be provided for a user by loading the tape cassette on a tape print device so as to print characters or the like on the tape by means of a thermal head and a platen or other print mechanism.

What is claimed is:

1. A tape, comprising:
a base material having a pair of cut lines cut in the base material in a vicinity of both sides in a width direction of the tape along a length of the tape.
an adhesive agent; and
a separating sheet bonded separably to one face of the base material via the adhesive agent, the separating sheet having a cut line in the separating sheet scored along the length of the tape.

2. The tape according to claim 1, wherein the cut line in the separating sheet is formed in a portion of the separating sheet opposing an interval between the pair of the cut lines in the base material.

3. The tape according to claim 2, wherein a cut line of the pair of cut lines in the base material is located apart from each side, in the width direction of the tape, by a predetermined distance.

4. The tape according to claim 3, wherein both side portions in the width direction of the tape base material are removed from the separating sheet along the cut lines in the base material.

5. The tape according to claim 2, wherein both side portions in the width direction of the tape base material are removed from the separating sheet along the cut lines in the base material.

6. The tape according to claim 1, wherein a cut line of the pair of cut lines in the base material is located apart from each side, in the width direction of the tape, by a predetermined distance.

7. The tape according to claim 6, wherein both side portions in the width direction of the tape base material are removed from the separating sheet along the cut lines in the base material.

8. The tape according to claim 1, wherein both side portions in the width direction of the tape base material are removed from the separating sheet along the cut lines in the base material.

9. A tape cassette containing a tape described in claim 1.

10. A tape, comprising:
a separating sheet having a cut line therein;
an adhesive agent overlying the separating sheet with a separating agent therebetween; and
a base material on the adhesive, wherein the base material at least covers a central portion, in a width direction of the tape, along a length of the tape.

11. The tape according to claim 10, wherein the cut line of the separating sheet extends substantially along a center, in the width direction, of the tape.

12. The tape according to claim 10, wherein portions clear of base material occur along both sides, in the width direction of the tape, of the separating sheet.

13. The tape according to claim 12, wherein the clear portions may be gripped by a user.

14. The tape according to claim 10, wherein the base material extends across the width of the tape for an entire length of the tape.

15. The tape according to claim 14, wherein the base material includes a cut line offset from each side, in the width direction, of the tape along the entire length.

16. The tape according to claim 15, wherein the offset from each side of the tape is equal.

17. The tape according to claim 16, wherein the offset allows side portions defined by the cut lines in the base material that may be gripped by a user.

18. A tape cassette using a tape according to claim 10.

19. A method of using a printed tape having a separating sheet with a cut line, an adhesive agent mounted to a base material overlying the separating sheet, the base material one of completely covering the separating sheet and have a cut line offset from each side, in a width direction of the tape, or the base material only covering a central portion of the separating sheet leaving clear portions along the sides of the tape and either the clear side portions or side portions defined by the cut lines extend the length of the tape, the method comprising:
gripping the tape at an end, after printing, in the clear portions or the side portions;
separating the gripped ends to divide the separating sheet along the cut line; and
creating a printed tape strip of base material having an adhesive surface.
